(19) United States
(12) Patent Application Publication
(10) Pub. No.: US 2020/0339762 A1
(43) Pub. Date: Oct. 29, 2020

(54) MODIFIED AEROGEL POWDER WITH SPECIAL FUNCTION GROUP FOR USE IN PLASTIC COMPOSITE AND FIBER SPINNING AND PREPARATION METHOD THEREOF

(71) Applicant: Taiwan Aerogel Technology Material Co., Ltd., Tainan City (TW)

(72) Inventors: Jean-Hong CHEN, Tainan City (TW); Shiu-Shiu CHEN, Tainan City (TW)

(21) Appl. No.: 16/397,120

(22) Filed: Apr. 29, 2019

(51) Int. Cl. C08J 3/075; D01D 5/04; B01J 13/00

(52) U.S. Cl. CPC C08J 3/075; D01F 6/60; B01J 13/0091; D01D 5/04

(57) ABSTRACT

A surface modified aerogel powder with special function group for used in plastic composite and fiber spinning applications are made from the following steps: (1) mixing step; (2) hydrolysis step; (3) condensation step within dispersion condition; (4) surface modification step; (5) solvent evaporation and drying step.

### FIELD OF THE INVENTION

The present invention is about a functional modified aerogel powder and its preparation method for use in plastic composites materials and fiber spinning, especially combining modifiers of various different function groups and continuous manufacture of sol-gel synthesis method for aerogel, in order to improve the application properties of functional modified aerogel powder and its production rate. This invention indicates addition of a special function group both inside of the aerogel and on its surface to enhance the combining force of the functional modified aerogel to plastic or adhesive substrate in the post-processing, and to facilitate increase the amount of the functional group modified aerogel powder on plastic and colloid substrate in post-processing and the property that the functional group modified aerogel powder can uniformly disperse in a substrate, so that the spinning property of the aerogel composite and its application in post-processing of textile can be improved.

### BACKGROUND OF THE INVENTION

Aerogel is a porous material with stereoscopic network structure, a technological product of low density, high specific surface area and low thermal conductivity. Currently it is mainly used in thermal insulative material. Since aerogel powders have very low bulk density (0.04-0.2 g/cm³), having large disparity in density to the plastic materials (0.8-1.35 g/cm³) at post-processing and blending, plus its extremely large specific volume, it is necessary to increase the amount of aerogel to reach effective functionality for the plastic composite and textile industries, such as light weight, high thermal insulation, strong fireproof and low melting drop. Hence, a large amount of aerogel is needed to add into organic plastic. Yet currently the aerogel on the market is merely hydrophobically modified powder, so its chemical structure has little suitability to plastic substrates in textile and plastic composite industries. As a result, currently commercialized hydrophobic aerogel powder has bad operability in blending with plastic. The amount of aerogel added is insufficient and it tends to aggregate inside the plastic, which leads to breakage of spinning during process. Particularly, aerogel powder blended plastic is prone to produce high pressure dust, and thus limits its applicability in spinning process. To solve these problems, this patent develops a continuous manufacture of an improved sol-gel synthetic technique combining later surface modification, making aerogel continuously modified in liquid phase to produce aerogel powder fit for plastic composite, fiber spinning and post-processing in textile applications. To enhance effective modification of aerogel, this invention takes continuous two-step modification technique: The first part hydrolytic modification and second part aging surface modification, which facilitates effective modification of aerogel powder and its combining force to plastic substrate to increase the amount and dispersion. During the post-processing of aerogel powders, due to its fragile structure, aerogel powder tends to break upon the stress of cutting when it blends plastic under high temperature. Consequently, only processing surface modification of aerogel powder is also prone to result in bad modification because of breakage. Therefore, this invention adopts two-step continuous modification to make aerogel powder obtain effective inside and surface modification. In the light of the present technique, aerogel molecules undergo surface modification during condensation process to effectively suits plastic's chemical structure of post-processing. Thus, a modified aerogel powder applicable to spinning and textile process is prepared.

Conventional preparation of aerogel is sol-gel synthesis, which mainly starts by mixing precursors such as alkoxysilane, tetramethyl orthosilicate or sodium metasilicate with organic solvent and follows by acid-catalyzed hydrolysis. After a certain time for hydrolysis, basic catalyst is added to trigger condensation, and during the process sol is gradually formed. The molecule inside the sol continues to form bond of condensation, gradually turning into a semi-solid macromolecule gel. Again, after a certain time for aging, the gel forms a stereoscopic network of stable structure. Finally, the solvent such as water and methanol in aerogel system is extracted through supercritical drying technique to obtain porous dry aerogel powder.

In addition, the preparation method of hydrophobic aerogel is sol-gel synthesis, which mainly starts by mixing methyl alkoxysilane precursor such as MTMS or MTES with organic solvent and follows by one-step hydrolysis upon addition of basic catalyst. After a certain time for hydrolysis, condensation occurs to gradually form sol. The molecule inside the sol continues to form bond of condensation, gradually turning into a semi-solid macromolecule gel. Again, after a certain time for aging, IPA or ethanol is used for solvent exchange for two to three days, letting hydrophobic gel form a stereoscopic network of stable structure. Finally, the solvent such as IPA or ethanol in aerogel system is removed through ambient pressure drying technique to obtain porous dry aerogel bulk.

The above preparation method of aerogel adopts supercritical drying technique or repetitive solvent exchange for two to three days, so the breakage caused by surface tension during the ambient drying process can be avoided. Yet the supercritical drying technique needs high pressure, so it is only suitable for drying a very small amount of aerogel. In contrast, solvent exchange is too long time consuming to be favored for mass production and lower the production cost.

On the other hand, currently commercialized aerogel is chiefly hydrophobic aerogel powder, which only disperses in oil-soluble system but not in aqueous solution system. Besides, currently commercialized hydrophobic aerogel powder does not mix well or cannot mix in big quantity when blending plastic materials. These phenomena are mainly because the aerogel's surface attributes do not suit the plastic's, and thus cause that the aerogel cannot disperse uniformly in the plastic.

### SUMMARY OF THE INVENTION

Therefore, to improve the past problem of breakage and performance reduction caused by bad dispersion of aerogel in plastic composite during the post-processing or spinning procedure, the inventors suggest a preparation method of combining function group modifier and aerogel precursor to produce modified aerogel powder for textile and fiber spinning. It includes the following steps: (1) Mixing step: mixing an alkoxysilane compound such as tetramethoxysilane (TMOS) or tetraethoxysilane (TEOS), function group modified alkoxysilane such as methyltrimethoxysilane (MTMS) or aminopropyltriethoxysilane (APTE), and a mixture of organic solvents to form a mixture solution. In the production of this function group modified aerogel powder, a function group modifier is added to modify the function group of microstructure in the aerogel system. (2) Hydrolysis step: adding one acid catalyst to the mixture solution for the hydrolysis reaction. Some aerogel modification process does not need to add acid catalyst to trigger hydrolysis. (3) Condensation plus dispersion step: adding one base catalyst to the mixture solution for condensation reaction, and then adding a hydrophobic dispersing solvent during the condensation process with rapid stir, so that the condensation solution forms hydrosphere particles of diameter 10 nm-500 μm in the stirring process, which later form stable wet-gel particles of diameter 10 nm-500 μm upon gelation in rapid stir. In condensation plus dispersion step, control the ratio of alkoxysilane, function group modified alkoxysilane and function group modifier in the mixture solution, meanwhile adjust hydrophobic dispersing solvent's property to enable the function group of modified alkoxysilane present on the surface of aerogel molecule, and later to form function group modified wet-gel particles of diameter 10 nm-500 μm upon aggregation during condensation. (4) Further surface modification step: adding surface modifier in the dispersed function group modified wet-gel particle system to further modify the surface of wet-gel particle. In this surface modification step, add again the surface function group modifier to modify the entire structure and apparent surface of aerogel, so that both the surface of aerogel's micropore and main body are modified sufficiently. (5) Solvent evaporation and drying step: evaporating the solvent to dry under ambient pressure, or drying the wet-gel particle after filtration, to produce a uniformly modified aerogel powder of certain function group and of diameter 10 nm-500 μm. The overall process of this technique is simple and capable of preparing aerogel particles of surface function group. The duration of the process is significantly reduced to 8 to 12 hours for preparation of surface function group aerogel powder, with which the productivity is increased.

Preferably, function group modified alkoxysilane can be divided into hydrophilically modified alkoxysilane and hydrophobically modified alkoxysilane. The former compound is one or a combination of several materials selected from the group consisting of alkoxysilane such as tetramethoxysilane (TMOS) or tetraethoxysilane (TEOS), R group-trimethoxysilane (R-TMS) or R group-triethoxysilane (R-TES); each R group is a hydrophilic group comprising a carboxyl group (—COOH), an amino group (—NH₂), an imino group (═NH), a polyamino group (—NH—NH₂), a hydroxyl group (—OH), an amido group (—CONH—), an epoxy group (—COH—COH), an uricyl group (—NHCONH—), an isocyanate group (—N═C═O), or an isocyanurate group (—N—CO—N—) and has 1-8 carbon atom(s).

Preferably, the hydrophobically modified alkoxysilane is one or a combination of several materials selected from the group consisting of alkoxysilane such as tetramethoxysilane (TMOS) or tetraethoxysilane (TEOS), R′ group-trimethoxysilane (R′-TMS) or R′ group-triethoxysilane (R′-TES), R′ group-polydimethylsiloxane (PDMS or DMDMS), a silica gel precursor, or R′ group-alkenyl alkyl silane coupling agent; each R′ group is a hydrophobic group comprising an alkyl group (—CH₃), an alkenyl group (—CH═CH₂), an ester group (—CO—O—), an ether group (—C—O—C—), an aromatic group (—C₆H₄—), or a halogen (—X) and has 1-13 carbon atom(s).

Preferably, the mixture of organic solvents is one or a combination of several materials selected from the group consisting of water, alcohol, amine, acid, ketone, ether, ester, aromatic hydrocarbon or alkane.

Preferably, the dispersion solvent comprises hydrophilic function group modified alkoxysilane or hydrophobic function group modified alkoxysilane on demand. Add a large amount of dispersion solvent to the mixture solution during the condensation process of a common alkoxysilane and hydrophilic function group modified alkoxysilane, such as one or a combination of several materials selected from water, alcohol, ketone, ether, ester, aromatic hydrocarbon or organic halide, which enables the surface of aerogel wet-gel particles to have modified hydrophilic function group, like —OH, —COOH or —NH₂. Under the force of dispersion solvent, the modified hydrophilic function group presents on the shell surface of the aerogel wet-gel particle prepared, which forms hydrophilic function group modified aerogel particle after drying.

Preferably, add a large amount of dispersion solvent to the mixture solution during the condensation process of a common alkoxysilane and hydrophobic function group modified alkoxysilane, such as one or a combination of several materials selected from water, alcohol, ketone, ether, ester, aromatic hydrocarbon, alkane, aryl halide or halogenated olefin, which enables the surface of aerogel wet-gel particles to have modified hydrophobic function group, like —CH₃, —C₂H₅, —C₆H₅, CH₂X, —C₆H₄X. Under the force of dispersion solvent, the modified hydrophobic function group presents on the shell surface of the aerogel wet-gel particle prepared, which forms hydrophobic function group modified aerogel particle after drying.

Preferably, consequent surface function group modification: Add surface modifier in the dispersed function group modified wet-gel particle system to further modify the function group of wet-gel particles. In this step the aim is to further modified the not yet modified surface structure of the wet-gel, so that the surface of aerogel's entire structure is modified to enhance the performance of modification of aerogel's micro-surface and main body surface.

Preferably, in this process the solvent is evaporated and the function group modified aerogel wet-gel particle is dried under atmospheric pressure and high temperature. The function group modified aerogel powder for plastic composite or spinning fiber is obtained after drying. The whole process is simple and capable to prepare the aerogel powder of diameter 10 nm-500 μm whose hydrophobic function group may be modified differently according to substrate's property. The process' duration is diminished to 3 to 12 hours and is capable of continuous manufacturing special hydrophobic function group modified aerogel powder, and thus increases the productivity.

The present invention provides the following advantages:

1. The preparation method of this invention is capable of producing the aerogel particle with special function group on micro-surface through blending different ratio of alkoxysilane and modified alkoxysilane, including hydrophilic and hydrophobic function group modified aerogel, to acquire excellent or notably improved fiber spinning property for plastic composite and post-processing, thus augmenting aerogel powder's applicability.

2. The preparation method of this invention is capable of controlling the porosity and cavity size of function group modified aerogel particle according to its condition (solvent content, solvent viscosity, acid catalyst or base catalyst content, dispersion solvent's composition, dispersion solvent content, stirring rate and so on).

3. The preparation method of this invention is capable of producing the spherical particulate function group modified aerogel powder of uniform structure and diameter between 10 nm-500 m through rapid stir in large amount of dispersion solvent during the condensation plus dispersion step. The outer shell of the modified aerogel particle's surface can be hydrophilic as well as hydrophobic function group, and its excellent dispersion ability can acquire the aerogel particle of excellent machinability or notably improved fiber spinning property, augmenting the practicality of aerogel powder.

4. The surface of the function group modified aerogel particle in this invention can be hydrophilically modified, so the function group modified aerogel can easily and uniformly disperse in a hydrophilic solvent, like water or alcohol, or can be easily combined or disperse on a hydrophilic substrate, or can be added to a substrate capable of combining with hydrophilic function group like plastic, rubber or fiber for a composite. A plastic composite with high content aerogel powder of excellent dispersion is formed to keep high inner porosity for post-processing or fiber spinning, and thus the thermal insulation is improved in various substrates.

5. The surface of the function group modified aerogel particle in this invention can be hydrophobically modified, so the function group modified aerogel can easily and uniformly disperse in a hydrophobic solvent, like hexane or toluene, or can be easily combined with hydrophobic adhesive, plastic, rubber or fiber substrate, or can uniformly disperse in hydrophobic substrate for a composite. A plastic composite with high content aerogel powder of excellent dispersion is formed to keep high inner porosity for post-processing or fiber spinning, and thus the thermal insulation is improved in various substrates.

6. This invention is capable of diminishing function group modification time by controlling the temperature condition. The continuous preparation of function group modified aerogel particle can be done as fast as in 3 to 8 hours, and thus increases the productivity.

7. This invention is capable of modifying the aerogel powder's function group according to substrate's chemical structure difference, so the function group modified aerogel of this invention can widely apply to the plastic, like polyester (PET, PBT, PLA, . . . ), polyamide (Nylon-6, Nylon-66, Nylon12, . . . ), polyolefin (PE, PP, PEP, . . . ), polyacrylate (PMMA, PVAc, . . . ), for blending or reeling. The function group modified aerogel of this invention can widely apply to the rubber for blending, like natural rubber, chlorinated rubber or isoprene rubber. The function group modified aerogel of this invention can widely apply to the adhesive for blending, like poly(methyl methacrylate) (PMMA) glue, polyurethane (PU) glue or polyvinyl acetate (PVAc) glue.

### BRIEF DESCRIPTION OF THE DRAWINGS

FIG. 1 is a flow chart of hydrophilic function group modification in this invention;

FIG. 2 is an SEM image of the function group modified aerogel powder prepared in this invention;

FIG. 3 is a TEM image of the function group modified aerogel powder prepared in this invention;

FIG. 4 is a picture of the hydrophilic amino group modified aerogel powder and the same blending Nylon particle prepared in this invention;

FIG. 5 is a picture of the hydrophobic methyl group modified aerogel powder and the same blending polypropylene particle prepared in this invention;

FIG. 6 is a picture of the function group modified aerogel powder and spinning fiber in this invention;

FIG. 7 is an SEM image of the section cut from the spinning fiber blending the function group modified aerogel powder in this invention;

FIG. 8 is a magnified SEM image of the section cut from the spinning fiber blending the function group modified aerogel powder in this invention; and

FIG. 9 is a magnified SEM image of the section cut from the spinning fiber blending the function group modified aerogel powder in this invention.

### DETAILED DESCRIPTION OF THE INVENTION

The detailed description and preferred embodiments of the invention will be set forth in the following content, and provided for people skilled in the art so as to understand the characteristics of the invention.

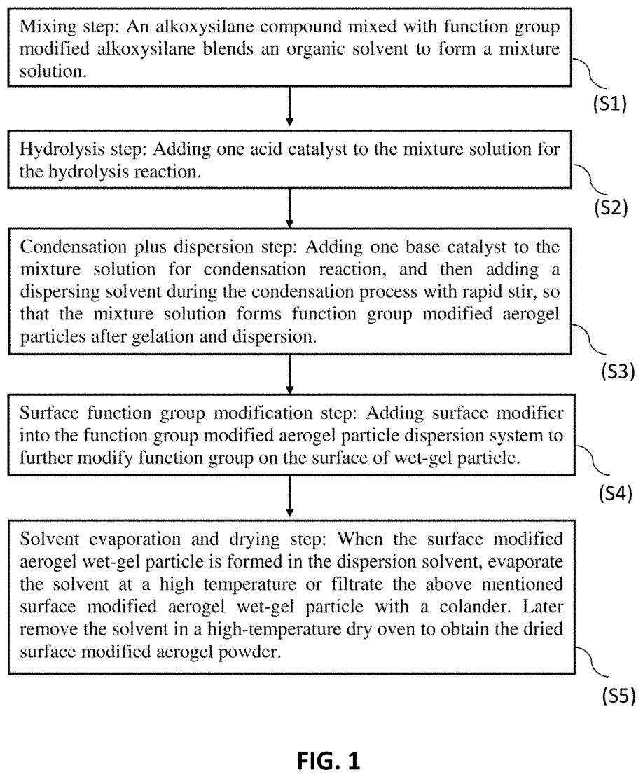

Please refer to FIG. 1, which reveals the embodiment of preparing method of hydrophilic aerogel particle and hydrophobic aerogel particle in this invention, including the following steps: mixing step (S1), hydrolysis step (S2), condensation plus dispersion step (S3), surface function group modification step (S4) and solvent evaporation and drying step (S5). Wherein:

The mixing step (S1): An alkoxysilane compound mixed with function group modified alkoxysilane blends an organic solvent to form a mixture solution. The alkoxysilane compound is the precursor like tetramethoxysilane (TMOS), tetraethoxysilane (TEOS) or tetramethyl orthosilicate. The function group modified alkoxysilane is a hydrophobic compound like methyltrimethoxysilane (MTMS) or a hydrophilic compound like aminopropyltriethoxysilane (APTE), to which an organic solvent is added to form a mixture solution. The hydrophilic function group modified alkoxysilane compound is one or a combination of several materials selected from the group consisting of R group-trimethoxysilane (R-TMS) or R group-triethoxysilane (R-TES); each R group is a hydrophilic group comprising a carboxyl group (—COOH), an amino group (—NH₂), an imino group (═NH), a hydroxyl group (—OH), an amido group (—CONH—), an epoxy group (—COH—COH), an uricyl group (—NHCONH—), an isocyanate group (—N═C═O), or an isocyanurate group (—N—CO—N—) and has 1-8 carbon atom(s), as shown in the mixing step (S1). Whereas the hydrophobic function group modified alkoxysilane compound is one or a combination of several materials selected from the group consisting of R′ group-trimethoxysilane (R′-TMS), R′ group-triethoxysilane (R′-TES), R′ group olefinic silica gel, or R′ group olefinic silane coupling agent; each R′ group is a hydrophobic group comprising an alkyl group (—CH₃), an alkenyl group (—C═CH₂), an ester group (—CO—O—), an ether group (—C—O—C—), an aromatic group (—C₆H₄—), or a halogen (—X) and has 1-13 carbon atom(s), as shown in the mixing step. The molar ratio of alkoxysilane compound and the function group modified alkoxysilane compound is within 0.0 mol % to 100.0 mol %. The addition of the modifier is to modify the function group in the microstructure of aerogel system. The content of alkoxysilane compound and hydrophobic function group modified alkoxysilane mixture is within 1.0 mol % to 60 mol %. The content of the organic solvent is within 99 mol % to 40 mol %.

The hydrolysis step (S2): add an acid catalyst to the mixture solution for hydrolysis, wherein the ratio between the total content of the alkoxysilane plus the function group modified alkoxysilane and the acid catalyst is 1:0.5-1:0.0001. Some aerogel modification process does not need to add acid catalyst to trigger hydrolysis.

In addition, the ratio of alkoxysilane compound and acid catalyst is 1:0.0001 to 1:0.5. When the ratio between the total content of the alkoxysilane plus the function group modified alkoxysilane and the acid catalyst is 1:0.0001, the hydrolysis takes 360 minutes. When the ratio between the total content of the alkoxysilane plus the function group modified alkoxysilane and the acid catalyst is 1:0.5, the hydrolysis takes 20 minutes. This thereby shows that the time of hydrolysis reduces as the content of acid catalyst increases.

The condensation plus dispersion step (S3): add a base catalyst to the mixture solution for condensation reaction. The ratio of acid catalyst's alcoholic solution and base catalyst's aqueous and alcoholic solution is 10:10 to 10:40. If the molar ratio of the base catalyst and the acid catalyst is 1.0:1.0 to 3.0:1.0, there is no need to add acid catalyst for hydrolysis but add proper amount of base catalyst for condensation.

In the base catalyst's alcoholic solution, the time of condensation is reduced notably as the content of the base catalyst increases (namely the gelation time of aerogel). When base catalyst: acid catalyst is 1.0:1.0, the gelation takes 1600 minutes. When base catalyst: acid catalyst is 3.0:1.0, the gelation time is reduced to 5 minutes. The process without the hydrolysis by acid catalyst can undergo condensation with addition of proper amount of base catalyst. Hence the process time can be adjusted by the content of base catalyst.

When the condensation reaction of the condensation plus dispersion step is nearly finished, the mixture solution forms sol first. Add a large amount of immiscible hydrophobic dispersion solvent to the mixture solution under the sol condition and rapidly stir at 200 rpm to 2000 rpm, so the mixture solution is influenced by the force of dispersion solvent under rapid stir to disperse the sol solution and forms 10 nm-500 μm sol particle, which later gelates to form pearly or spherical wet-gel particle. Above mentioned wet-gel particle has diameter of 10 nm-500 μm, and the volume ratio of the mixture solution and dispersion solvent is 1.0:0.5-1.0:5.0. The more the content of dispersion solvent has, the better the uniformity and dispersion of the aerogel particle prepared has.

The dispersion solvent for the preparation of hydrophilic aerogel particle in the condensation plus dispersion step (S3) can be water, distilled water, deionized water, C1-C16 alcohol, C2-C16 ether, C3-C16 ketone, C2-C16 ester, C1-C16 carboxylic acid, C1-C16 amine and so on. Practically, one or a mixture of different composition of water, distilled water, deionized water, methanol, ethanol, acetone, dibutyl ether, ethyl acetate, n-butyl acetate, formic acid or ammonia.

The dispersion solvent for the preparation of hydrophobic aerogel particle in the condensation plus dispersion step (S3) can be C3-C16 ketone, C2-C16 ether, C6-C16 aromatic hydrocarbon, C5-C16 alkane, C2-C16 halogenated ether, C2-C16 halogenated ester, C2-C16 aryl halide, C2-C16 haloalkane and so on. Practically, one or a mixture of different composition of acetone, dibutyl ether, ethyl acetate, n-butyl acetate, cyclohexane, n-hexane, toluene, kerosene or cleaning naphtha.

The surface function group modification step (S4): Add further surface modifier into the dispersion system of function group modified wet-gel particle for further modification. Herein the aim of modifying the function group of the aerogel powder is explicated as below: When the content of the function group modifier in step (1) is higher than 50 mol %, there is no need for further surface modification. Besides, the aim of the surface modification step is to modify the surface function group of aerogel's entire structure, so that both the surface of aerogel's micropore and main body are modified sufficiently. The hydrophilic surface function group modified alkoxysilane is one or a combination of several materials selected from the group consisting of R group-trimethoxysilane (R-TMS) or R group-triethoxysilane (R-TES); each R group is a hydrophilic group comprising a carboxyl group (—COOH), an amino group (—NH₂), an imino group (═NH), a hydroxyl group (—OH), an amido group (—CONH—), an epoxy group (—COH—COH), an uricyl group (—NHCONH—), an isocyanate group (—N═C═O), or an isocyanurate group (—N—CO—N—) and has 1-8 carbon atom(s), as shown in the modification step (S4). Whereas the hydrophobic surface function group modified alkoxysilane compound is one or a combination of several materials selected from the group consisting of R′ group-trimethoxysilane (R′-TMS), R′ group-triethoxysilane (R′-TES), R′ group olefinic silica gel, or R′ group olefinic silane coupling agent; each R′ group is a hydrophobic group comprising an alkyl group (—CH₃), an alkenyl group (—C═CH₂), an ester group (—CO—O—), an ether group (—C—O—C—), an aromatic group (—C₆H₄—), or a halogen (—X) and has 1-13 carbon atom(s), as shown in the mixing step.

The solvent evaporation and drying step (S5): when the surface modified aerogel wet-gel particle is formed in the dispersion solvent, evaporate the solvent at a high temperature to obtain the surface modified aerogel particle, or filtrate the above mentioned surface modified aerogel wet-gel particle with a colander. Remove the large amount of dispersion solvent from the surface modified aerogel wet-gel system to obtain the surface modified aerogel particle. Preferably, dry with fluidized bed reactor or thermostatic drying oven at 60-250° C. to fast dry the solvent-containing surface modified aerogel particle, so that the dried surface modified aerogel powder can be obtained.

Through this, spherical, uniform in size and highly porous surface modified aerogel powder is prepared, which enhances the modification uniformity in outer and inner structure of the modified aerogel particle. In addition, through this technique, the surface function group modified aerogel can apply to various organic substrates like plastics, rubbers or adhesives. The applicability of aerogel powder increases. Especially the preparation of the surface function group modified aerogel powder can apply to textile or and fiber spinning. It can notably improve the amount of addition and blending uniformity of the surface function group modified aerogel powder in plastic's post-processing and on fiber spinning substrate to enhance the machinability of the surface function group modified aerogel powder and plastic composite, to enhance the spinning property of aerogel particle during spinning process, and to facilitate the mass production of the aerogel for the expansion of industrial application.

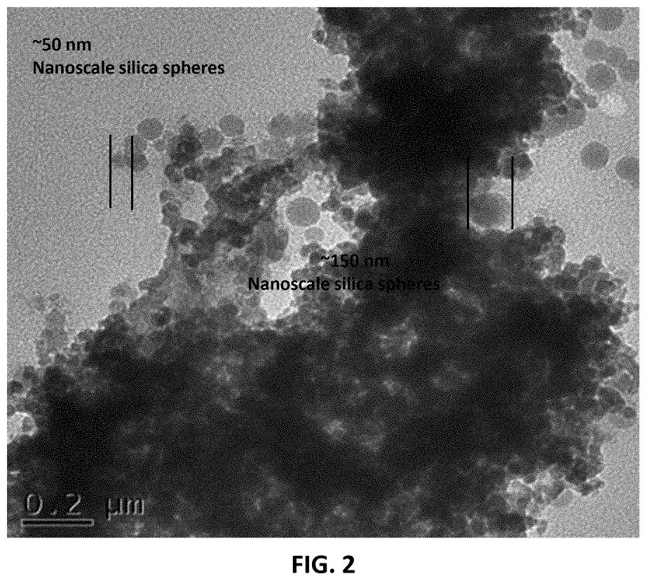

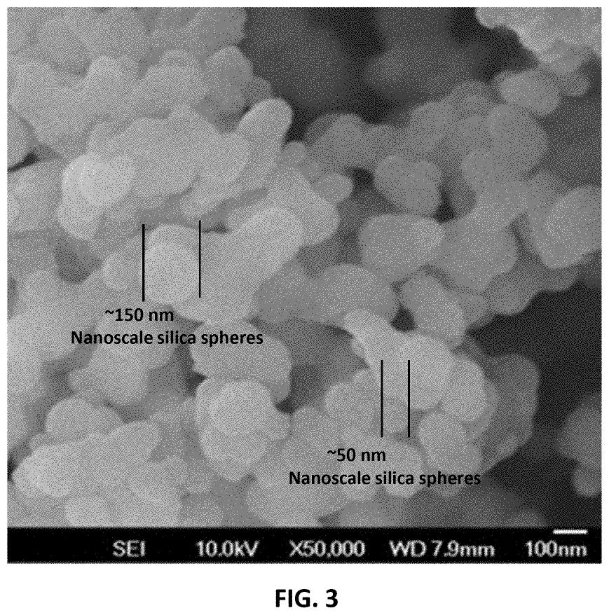

Please refer to FIGS. 2 and 3, which is transmission electron microscope (TEM) image and scanning electron microscope (SEM) image of the distribution and apparent size of the surface function group modified aerogel particle dispersed at 1600 rpm rapid stir. The images show that the apparent structure of the surface function group modified aerogel particle prepared has high uniformity with a spherical structure of diameter about 30-200 nm.

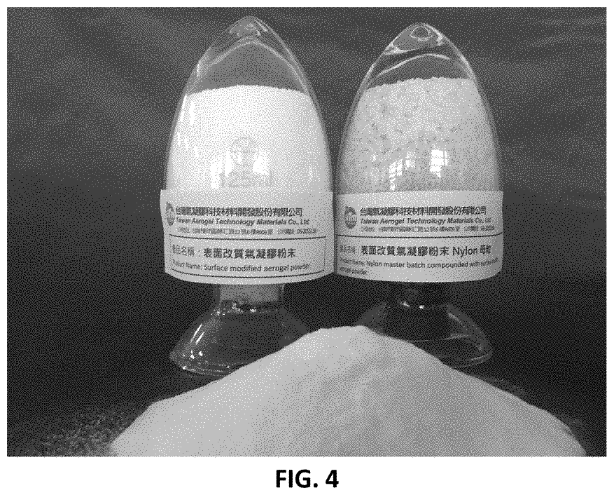

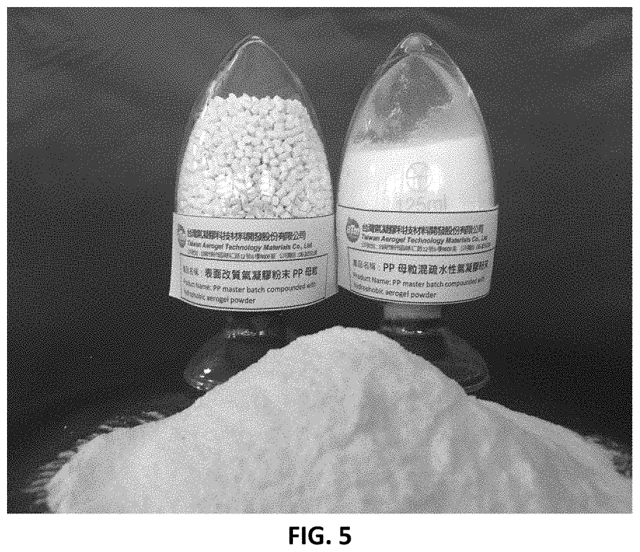

Please refer to FIGS. 4 and 5, which is the hydrophilic amino group modified aerogel particle and the same blending Nylon-6 and the hydrophobic methyl group modified aerogel particle and the same blending polypropylene (PP) particle. The images show that the surface function group modified aerogel particle prepared in this technique can highly blend different plastic substrates to form the plastic particle of high concentration of aerogel powder.

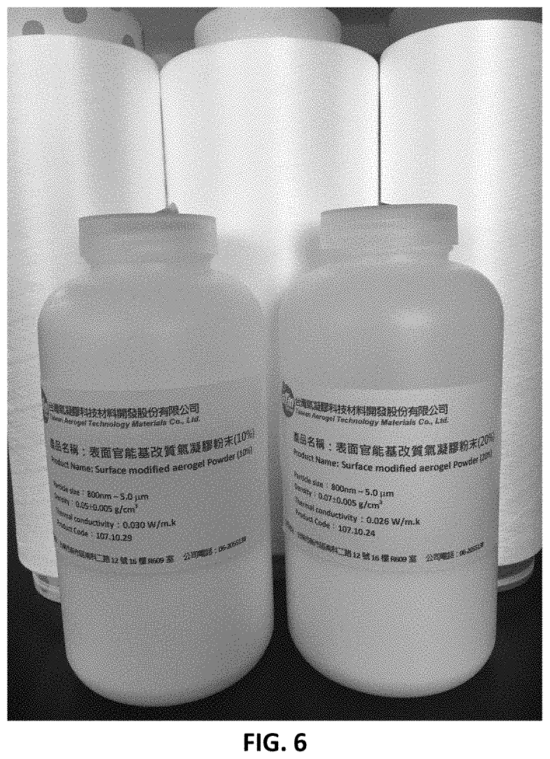

Please refer to FIG. 6, which is the surface function group modified aerogel particle prepared with different hydrophilic amino group and the Nylon spinning fiber blending 5%, 10% and 20% amino surface function group modified aerogel in the embodiment of this invention. The picture shows that the Nylon plastic blending 5%, 10% and 20% amino surface function group modified aerogel particle can produce the surface function group modified aerogel spinning fiber through spinning technique. The fiber spinning using the reeling technique of the function group modified aerogel particle can apply to common circular spinning, special-shaped section spinning, two components core-shell coaxial spinning, two components side-by-side spinning or multi-components multilateral spinning, so as to manufacture low-density, high warmth keeping, high coldness defending, anti-melting-drop and thermal insulative functional fiber.

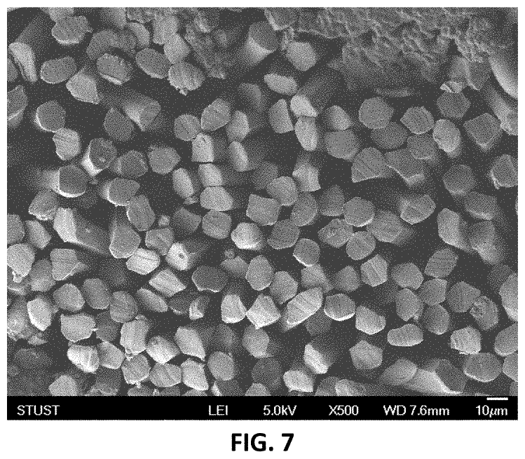

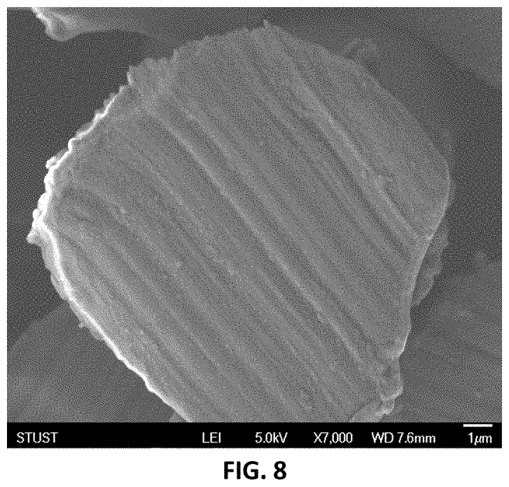

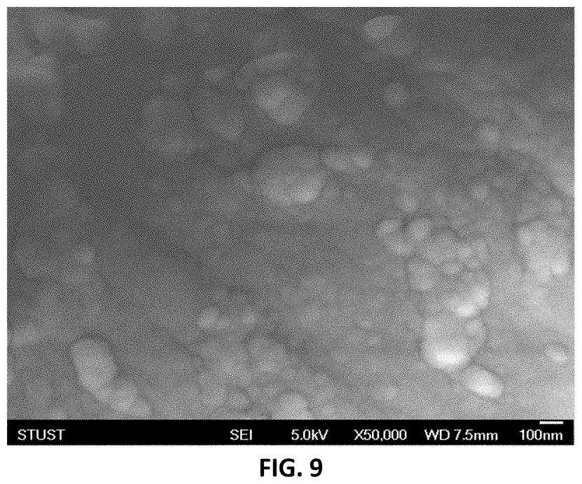

Please refer to FIGS. 7, 8 and 9, which are SEM images of different magnifications of the spinning fiber section of 20% amino surface function group modified aerogel blending Nylon. FIG. 7 shows the whole spinning fiber section of 20% amino surface function group modified aerogel blending Nylon at 500 magnification. FIG. 8 shows a single spinning fiber section of 20% amino surface function group modified aerogel blending Nylon at 7,000 magnification. FIG. 9 shows entire spinning fiber section of 20% amino surface function group modified aerogel blending Nylon at 50,000 magnification. As shown in the pictures, the apparent structure of the fiber section of the amino modified aerogel particle has high uniformity with a spherical structure of diameter about 30-200 nm, which is in accordance with the apparent structure of the surface function group modified aerogel powder shown in FIGS. 2 and 3. This signifies that the surface function group modified aerogel powder prepared is very suitable for spinning fiber application.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for manufacturing a function group modified aerogel particle for textile and fiber spinning, comprising:
mixing step: blending an alkoxysilane compound mixed with a function group modified alkoxysilane compound and an organic solvent to form a mixture solution;
hydrolysis step: adding one acid catalyst to the mixture solution for the hydrolysis reaction;
condensation plus dispersion step: adding one base catalyst to the mixture solution for condensation reaction, and then adding a dispersing solvent during the condensation reaction with rapid stir, so that the mixture solution forms function group modified aerogel particles after gelation and dispersion;
surface function group modification step: adding a surface modifier into the function group modified aerogel particles to further modify function group on the surface of each function group modified aerogel particle; and
solvent evaporation and drying step: when the surface modified aerogel particles are formed in the dispersion solvent, evaporating the solvent at a high temperature or filtrating the surface modified aerogel particles with a colander, and later removing the solvent in a high-temperature dry oven to obtain the dried surface modified aerogel powder.

2. The manufacturing method of a function group modified aerogel particle for textile and fiber spinning as claimed in claim 1, wherein the function group modified alkoxysilane compound is a hydrophilic function group modified alkoxysilane compound selected from the group consisting of R group-trimethoxysilane (R-TMS) and R group-triethoxysilane (R-TES); each R group is a hydrophilic group comprising a carboxyl group (—COOH), an amino group (—NH₂), an imino group (═NH), a hydroxyl group (—OH), an amido group (—CONH—), an epoxy group (—COH—COH), an uricyl group (—NHCONH—), an isocyanate group (—N═C═O), or an isocyanurate group (—N—CO—N—) and has 1-8 carbon atom(s).

3. The manufacturing method of a function group modified aerogel particle for textile and fiber spinning as claimed in claim 1, wherein the function group modified alkoxysilane compound is a hydrophobic function group modified alkoxysilane compound selected from the group consisting of R′ group-trimethoxysilane (R′-TMS), R′ group-triethoxysilane (R′-TES), R′ group olefinic silica gel, and R′ group olefinic silane coupling agent; each R′ group is a hydrophobic group comprising an alkyl group (—CH₃), an alkenyl group (—C═CH₂), an ester group (—CO—O—), an ether group (—C—O—C—), an aromatic group (—C₆H₄—), or a halogen (—X) and has 1-13 carbon atom(s).

4. The manufacturing method of a function group modified aerogel particle for textile and fiber spinning as claimed in claim 1, wherein the dispersion solvent is a hydrophilic solvent selected from the group consisting of water, distilled water, deionized water, alcohol, ether, ketone, carboxylic acid and amine.

5. The manufacturing method of a function group modified aerogel particle for textile and fiber spinning as claimed in claim 1, wherein the dispersion solvent is a hydrophobic dispersion solvent selected from the group consisting of ketone, ether, ester, aromatic hydrocarbon and alkane.

6. The manufacturing method of a function group modified aerogel particle for textile and fiber spinning as claimed in claim 1, wherein the surface function group modification step is provided for modifying the surface function group of the gelated mixture solution to enable the surface of the aerogel particle to form a complete function modified aerogel particle, enhancing the force between the aerogel powder and a substrate, and improving the aerogel's uniformity in a substrate to prevent breakage upon spinning caused by aggregation of the aerogel powder; wherein the surface modifier is a hydrophilic surface function group modifier selected from the group consisting of R group-trimethoxysilane (R-TMS) and R group-triethoxysilane (R-TES), and each R group is a hydrophilic group comprising a carboxyl group (—COOH), an amino group (—NH₂), an imino group (═NH), a hydroxyl group (—OH), an amido group (—CONH—), an epoxy group (—COH—COH), an uricyl group (—NHCONH—), an isocyanate group (—N═C═O), or an isocyanurate group (—N—CO—N—) and has 1-8 carbon atom(s), or the surface modifier is a hydrophobic surface function group modifier selected from the group consisting of R′ group-trimethoxysilane (R′-TMS), R′ group-triethoxysilane (R′-TES), R′ group olefinic silica gel, and R′ group olefinic silane coupling agent, and each R′ group is a hydrophobic group comprising an alkyl group (—CH₃), an alkenyl group (—C═CH₂), an ester group (—CO—O—), an ether group (—C—O—C—), an aromatic group (—C₆H₄—), or a halogen (—X) and has 1-13 carbon atom(s).

7. The manufacturing method of a function group modified aerogel particle for textile and fiber spinning as claimed in claim 1, wherein the solvent evaporation and drying step further comprises: evaporating the solvent under ambient pressure and high temperature or filtrating the aerogel particle with a colander, and then drying the function group modified aerogel particle at 60-250° C., wherein the drying is performed by a fluidized bed reactor, a thermostatic drying oven, a roll drying machine, an agitated dryer, a spray dryer or a vacuum drying equipment.

8. The manufacturing method of a function group modified aerogel particle for textile and fiber spinning as claimed in claim 1, wherein in the condensation reaction, the diameter, porosity and cavity size of the surface function group modified aerogel particle are tuned according to a reaction condition including the content of the alkoxysilane, the content of the function group modified alkoxysilane, the content of the solvent, the solvent viscosity, the content of the acid catalyst, the content of the base catalyst, the content of the dispersion solvent and the stirring rate.

9. The manufacturing method of a function group modified aerogel particle for textile and fiber spinning as claimed in claim 1, wherein in the condensation reaction, the mixture solution gelates to form the function group modified aerogel particle during the stir at 200 rpm to 2000 rpm, and the function group modified aerogel particle has diameter of 10 nm-500 μm.

10. A function group modified aerogel particle for textile and fiber spinning made according to the method as claimed in claim 1, wherein the function group modified aerogel particle is provided for being added to a substrate to improve the addition amount of the surface function group modified aerogel powder, enhance the spinning property of aerogel powder plastic during spinning process, and improve the applicability of the function group modified aerogel powder.

11. The function group modified aerogel particle for textile and fiber spinning as claimed in claim 10, wherein the spinning technique is common circular spinning, special-shaped section spinning, two components core-shell coaxial spinning, two components side-by-side spinning or multi-components multilateral spinning, so as to manufacture low-density, high warmth keeping, high coldness defending, anti-melting-drop and thermal insulative functional fiber.
